(19) United States
(12) Patent Application Publication
(10) Pub. No.: US 2015/0365290 A1
(43) Pub. Date: Dec. 17, 2015

(54) NETWORK VERIFICATION APPARATUS, NETWORK VERIFICATION METHOD AND PROGRAM

(71) Applicant: NEC Corporation, Minato-ku, Tokyo (JP)

(72) Inventor: Yutaka YAKUWA, Tokyo (JP)

(21) Appl. No.: 14/761,993

(22) PCT Filed: Jan. 22, 2014
(86) PCT No.: PCT/JP2014/051240

§ 371 Date: Jul. 20, 2015

(30) Foreign Application Priority Data
Jan. 23, 2013 (JP) 2013-009866

(51) Int. Cl. H04L 12/24; H04L 12/26

(52) U.S. Cl. CPC H04L 41/0873; H04L 43/50

(57) ABSTRACT

A device for network verification includes a verification information input unit that accepts input of information for verification which represents definition of a configuration of a network being verified and a behavior model of a component included in the network. The device also includes a verification code formulation unit that formulates, from the information for verification, a code for verification which verifies an over approximate model which is such a model that has corrected the behavior model so that the model obtained on correction does not have to resort to match conditions identifying a communication packet. The device also includes a model check execution unit that executes model checking using the code for verification, a counterexample validity confirmation unit that checks whether a counterexample obtained in the model checking is also present in an inherent behavior of the network, and a verified result output unit that outputs result of verification based on outputs of the model check execution unit and the counterexample validity confirmation unit.

### CROSS-REFERENCE TO RELATED APPLICATION

The present application is a National Stage Entry of PCT/JP2014/051240 filed Jan. 22, 2014, which is based on and claims the benefit of the priority of Japanese Patent Application No. 2013-009866, filed on Jan. 23, 2013, the disclosures of all of which are incorporated herein in their entirety by reference.

This invention relates to a network verification apparatus, a network verification method and a program and, in particular, to a network verification apparatus, a network verification method and a program in which a network being verified is modeled to perform its verification.

### TECHNICAL FIELD

### Background

For management and supervision of networks, a technique known as OpenFlow is stirring up notice (see Non-Patent Literatures 1 and 2). The OpenFlow is also attracting attention as a technique implementing the concept of the Software-Defined Networking, referred to below as ‘SDN’. This SDN is a new paradigm in the field of networks that monistically manages network control by a programmable method. In particular, the OpenFlow is felt to be promising in many respects including automation of network management, efficiency enhancement and power saving.

With the OpenFlow, flexibility of network control may truly be improved, however, there is a fear of enhanced susceptibility to faults which may compromise the improved flexibility. More precisely, programmers may commit bugs in the course of software programming or encounter faults resulting from combinations of multiple programs. Thus, for stabilized management of the OpenFlow network, it is crucial to verify at the outset whether or not the network is safe. In Non-Patent Literature 3, there is disclosed a tool known as ‘NICE’ which performs status exploration of the OpenFlow network by model checking. According to Non-Patent Literature 3, the ‘NICE’ symbolically executes a program of an OpenFlow controller to find out a collection of representative values of packets in order to exercise the total of code paths, and executes status exploration using the so found out collection of the representative packet values.

Non-Patent Literature 1:
Nick McKeown and seven others, “OpenFlow: Enabling Innovation in Campus Networks”, [online], [retrieved on December 26, Heisei24 (2012)], Internet <URL: https://www.openflow.org.documents/openflow-wp-latest.pdf>

Non-Patent Literature 2:
“OpenFlow Switch Specification” Version 1.0.0. (Wire Protocol 0x01), [online], [retrieved on December 26, Heisei 24 (2012)], Internet <URL: https://www.opennetworking.org/images/stories/downloards/specificati on/openflow-spec-v1.0.0.pdf>

Non-Patent Literature 3:
Marco Canini and four others, “A NICE Way to Test OpenFlow Applications”, [online], [retrieved on January 4, Heisei25 (2013)], Internet <URL: https://infoscience.epfl.ch/record/170618/files/nsdi-final.pdf>

### SUMMARY

The following analysis is by the present invention. The technique represented by the Non-Patent Literature 3 suffers a problem that principal operations of the OpenFlow network cannot be exhaustively verified with costs realistic both in time and machine resources, or that, since the costs incurred are not realistic, one refrains from performing exhaustive verification.

For example, in a technique disclosed in Non-Patent Literature 3, verification is carried out to exhaustively take account of the total of the code paths of the OpenFlow controller program. However, verification is not carried out to exhaustively take account of the OpenFlow network behaviors that may be influenced by the OpenFlow controller program, including, for example, the behavior of forwarding communication packets by the OpenFlow switches. There is thus a possibility that faults concerned with the principal behaviors of the OpenFlow networks cannot be detected.

The above mentioned problem is not innate to the OpenFlow techniques disclosed in Non-Patent literatures 1, 2, but may be said to be common to other networks called SDN.

It is an object of the present invention to provide a network verification apparatus, a network verification method and a program which may contribute to improved efficiency of exhaustive verification of a network represented by SDN.

In one aspect, there is provided an apparatus for verifying a network, comprising a verification information input unit that accepts an input of information for verification which represents definition of a configuration of a network being verified and a behavior model(s) of a component(s) included in the network, a verification code formulation unit that formulates, from the information for verification, a code for verification which verifies an over approximate model, a model check execution unit that executes model checking using the code for verification, a counterexample validity confirmation unit that checks whether or not a counterexample obtained in the model checking is also present in an inherent behavior of the network, and a verified result output unit that outputs a result of verification based on outputs of the model check execution unit and the counterexample validity confirmation unit. The over approximate model is such a model that has corrected the behavior model so that the model obtained on correction does not have to resort to match conditions identifying a communication packet.

In another aspect, there is provided a method for verifying a network, comprising: accepting an input of information for verification which represents definition of a configuration of a network being verified and a behavior model(s) of a component(s) included in the network, formulating, from the information for verification, a code for verification which verifies an over approximate model, executing model checking using the code for verification, checking whether or not a counterexample obtained in the model checking is also present in an inherent behavior of the network, and outputting a result of verification based on outputs of the model check execution and the counterexample validity confirmation. The over approximate model is such a model that has corrected the behavior model so that the model obtained on correction does not have to resort to match conditions identifying a communication packet. The present invention is bound up to a particular machine which is a computer configured to execute model checking of the network.

In yet another aspect, there is provided a non-transitory computer-readable recording medium storing thereon a program that causes a computer that verifies a behavior of a network to perform processing for: accepting an input of information for verification which represents definition of a configuration of a network being verified and a behavior model(s) of a component(s) included in the network, formulating, from the information for verification, a code for verification which verifies an over approximate model, executing model checking using the code for verification, checking whether or not a counterexample obtained in the model checking is also present in an inherent behavior of the network, and outputting a result of verification based on outputs of the model check execution and the counterexample validity confirmation. The over approximate model is such a model that has corrected the behavior model so that the model obtained on correction does not have to resort to match conditions identifying a communication packet. The program can be recorded on a computer-readable, that is, transient, recording medium. Viz., the present invention can be implemented as a computer program product.

The meritorious effects of the present invention are summarized as follows.

According to the present invention, it is possible to contribute to improved efficiency of exhaustive verification of a network represented by SDN. That means that the present invention transforms the prior art structure into that having improved efficiency of exhaustive verification of such a network.

### BRIEF DESCRIPTION OF THE DRAWINGS

FIG. 1 is a block diagram showing a configuration of an exemplary embodiment according to the present disclosure.

FIG. 2 is a block diagram showing a configuration of a device for network verification of an exemplary embodiment 1 according to the present disclosure.

FIG. 3 is a flowchart showing a smallest example behavior model of an OpenFlow switch of Non-Patent Literature 2.

FIG. 4 is a flowchart showing a smallest example behavior model of an OpenFlow controller of Non-Patent Literature 2.

FIG. 5 is a diagram showing a sequence of operations of the device for network verification of the exemplary embodiment 1 according to the present disclosure.

FIG. 6 is a flowchart showing the operation of an over approximate model formulation unit of the device for network verification of the exemplary embodiment 1 according to the present disclosure (the operation of formulating an over approximate model from a terminal behavior model).

FIG. 7 is a flowchart showing the operation of the over approximate model formulation unit of the device for network verification of the exemplary embodiment 1 according to the present disclosure (the operation of formulating the over approximate model from a switch behavior model).

FIG. 8 is a flowchart showing the operation of the over approximate model formulation unit of the device for network verification of the exemplary embodiment 1 according to the present disclosure (the operation of formulating the over approximate model from a controller behavior model).

FIG. 9 is a flowchart showing a smallest example behavior model of a network component postulated in an exemplary embodiment 2 according to the present disclosure.

FIG. 10 is a flowchart showing the operation of an over approximate model formulation unit of a device for network verification in the exemplary embodiment 2 according to the present disclosure (the operation of formulating an over approximate model from a behavior model of a network component).

FIG. 11 is a block diagram showing a configuration of a device for network verification in an exemplary embodiment 3 according to the present disclosure.

### PREFERRED MODES

Initially, a summary of an exemplary embodiment of the present disclosure will be described with reference to the drawings. It is noted that symbols for referencing the drawings are entered in the summary merely as examples to assist in understanding and are not intended to limit the present disclosure to the mode illustrated.

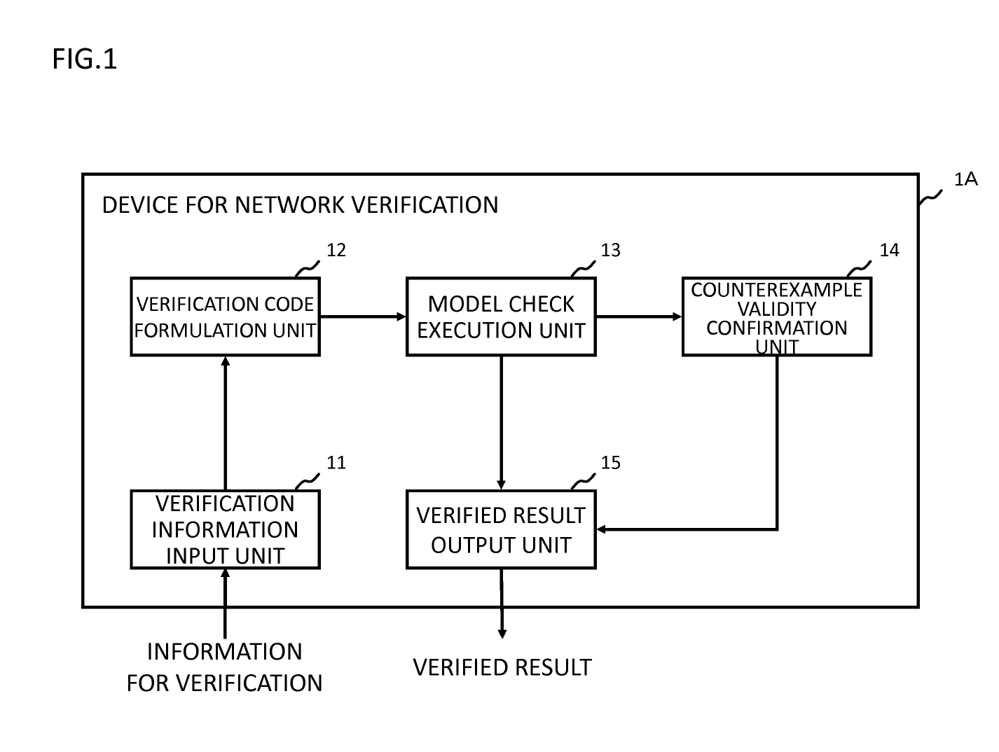

Referring to FIG. 1, an exemplary embodiment of the present disclosure may be implemented by a device for network verification 1A which is made up by a verification information input unit 11, a verification code formulation unit 12, a model check execution unit 13, a counterexample validity confirmation unit 14 and a verified result output unit 15.

Specifically, the verification information input unit 11 accepts an input of the information for verification which is a definition of a configuration of a network being verified and a behavior model of each of a variety of components composing the network. From the information for verification, the verification code formulation unit 12 formulates a code for verification that may be used for verifying an over approximate model in the network. The over approximate model is such a model obtained on correcting the behavior model so that the model obtained on correction does not have to resort to match conditions identifying a communication packet. The model check execution unit 13 executes model checking using the code for verification. If, as a result of the model checking, a proof testifying to the presence of a state violating a property (a requested specification) or properties has been found, the model check execution unit 13 outputs a counterexample(s). The counterexample validity confirmation unit 14 checks to see whether or not the counterexample(s) persists in an intrinsic behavior of the network as well. The verified result output unit 15 outputs the result of the verification based on outputs of the model check execution unit and the counterexample validity confirmation unit 14.

With the above mentioned configuration, exhaustive model checking is carried out in the model check execution unit 13. Moreover, detection of faults becomes possible since the validity of the counterexample(s), obtained by the model checking, can be confirmed by the counterexample validity confirmation unit 14.

### Exemplary Embodiment 1

### Explanation of Configuration

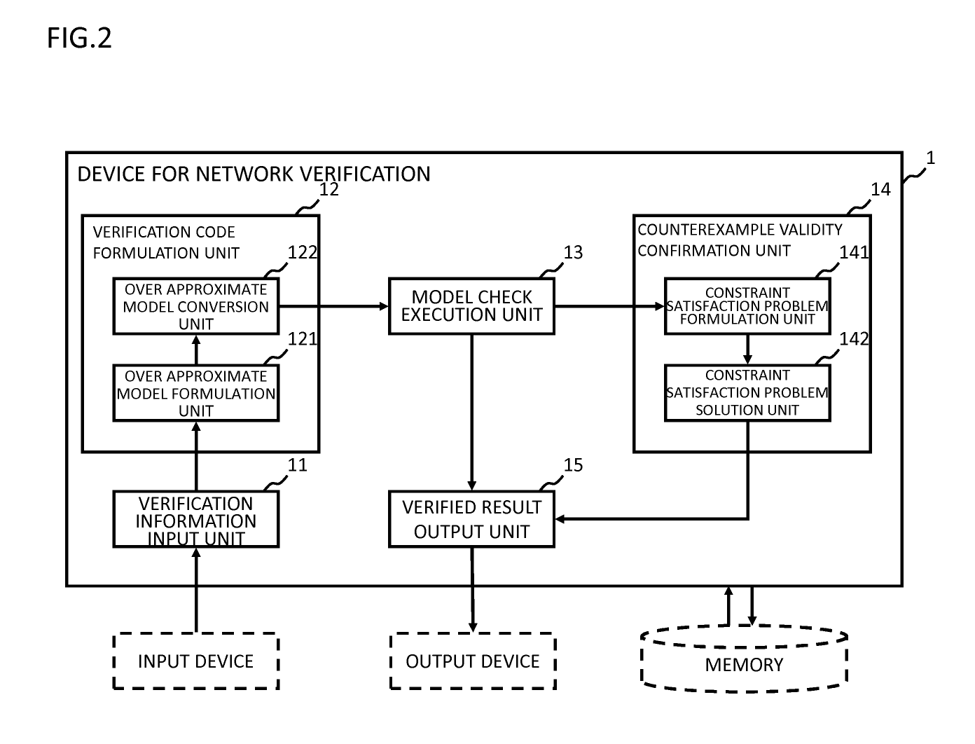

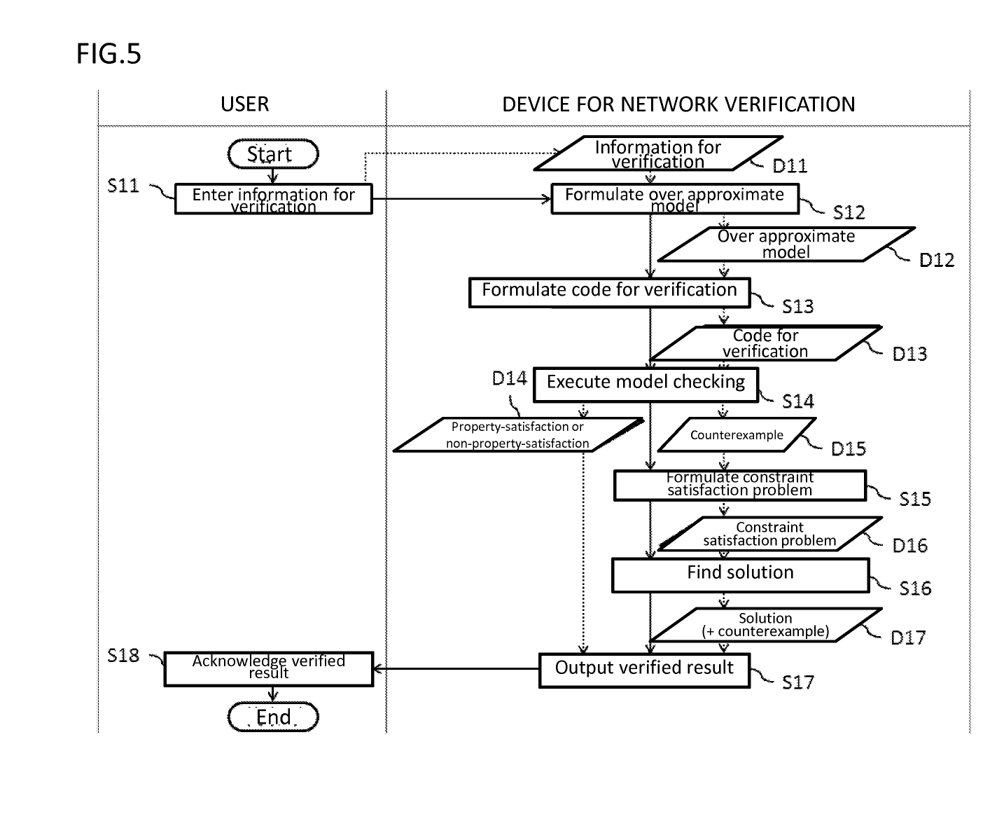

An exemplary embodiment 1 according to the present disclosure will now be described in detail with reference to the drawings. FIG. 2 depicts a block diagram showing a configuration of a device for network verification according to the exemplary embodiment 1 of the present disclosure. Referring to FIG. 2, there is shown a configuration of the device for network verification of the exemplary embodiment 1 including the verification information input unit 11, verification code formulation unit 12, model check execution unit 13, counterexample validity confirmation unit 14 and the verified result output unit 15. Also, in the following explanation, symbols D11 to D17 depict input/output information and intermediate codes etc. of the device for network verification (see FIG. 5).

The verification code formulation unit 12 includes an over approximate model formulation unit 121 and an over approximate model conversion unit 122 as later explained. The counterexample validity confirmation unit 14 includes a constraint satisfaction problem formulation unit 141 and a constraint satisfaction problem solution unit 142, as also later explained.

The verification information input unit 11 is connected to the verification code formulation unit 12, connected in turn to the model check execution unit 13, which model check execution unit is connected to the counterexample validity confirmation unit 14 and the verified result output unit 15. The confirmation unit 14 is connected to the verified result output unit 15.

The relationship of interconnections and the behavior models of all terminals, all switches and a controller(s), together making up a network being verified, as well as the property or properties to be met by the network, are defined in information for verification D11, which is accepted as an input by the verification information input unit 11.

The ‘behavior model’ will now be explained. The behavior model is defined as a status machine that undergoes status transitions at the same time as activity steps as primitive behavior units are executed. The behavior model is individually defined for each terminal, each switch and each controller that together make up the network. If two or more of the behavior models operate in a similar manner, they do not have to be defined separately, provided that reference is made to the common behavior model. The behavior model of the entire network is defined as a global model synthesized from the total of the behavior models of individual terminals, switches and a controller(s) making up the network. In the subject exemplary embodiment, it is postulated that the behavior models as well as the relationship of interconnections of the switches and the controller(s) conform to the specification of the OpenFlow specification of Non-Patent Literature 2.

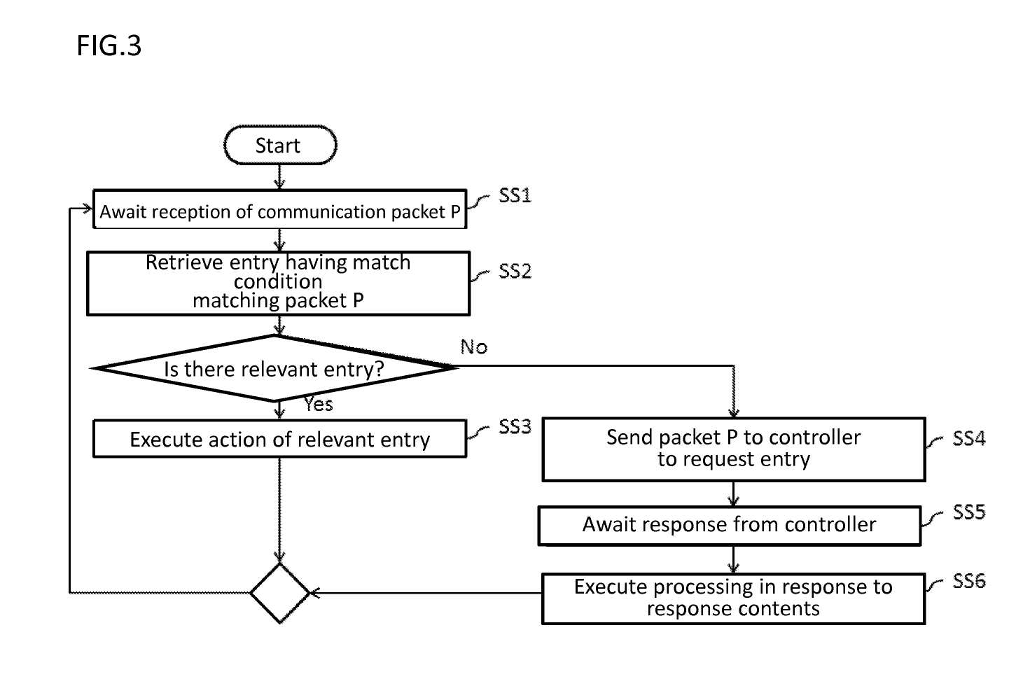

FIG. 3 depicts an example of a smallest behavior model of the OpenFlow switch of Non-Patent Literature 2. In the example of FIG. 3, an OpenFlow switch awaits receiving a communication packet(s) P (step SS1). On receipt of the packet, the OpenFlow switch searches entries (flow entries), already received from the controller, for such an entry having match conditions matching the received packet P (step SS2). If there is such entry having match conditions matching the received packet, the OpenFlow switch executes the contents of the action field of the entry (step SS3). If there is no entry having match conditions matching the received packet, the OpenFlow switch sends the communication packet P to the controller with a request for having an entry sent thereto (step SS4). The OpenFlow switch awaits a response from the controller (step SS5) and executes processing in accordance with the contents of the response (step SS6). The above described sequence of operations is reiterated. It is noted that the above steps represent a minimum set of operations. See also ‘3.4 Matching’ of Non-Patent Literature 2.

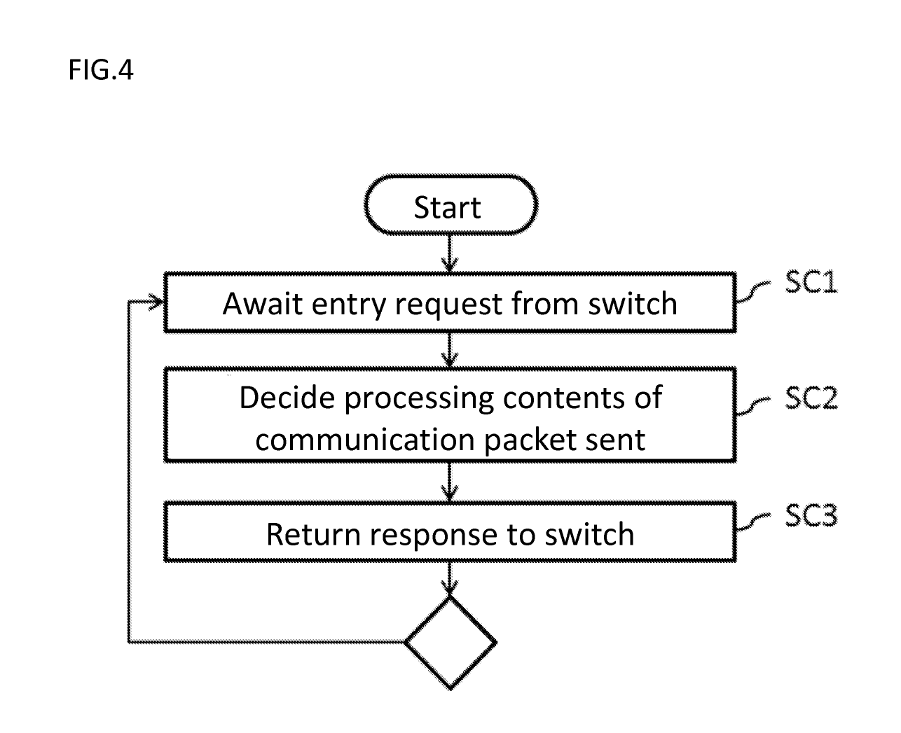

FIG. 4 depicts an example of the smallest behavior model for an OpenFlow controller of Non-Patent Literature 2. In the example of FIG. 4, the OpenFlow controller awaits an entry request from a switch (step SC1) and, on receipt of the entry request from the switch, decides on processing contents of a communication packet P transmitted thereto (step SC2). The OpenFlow controller returns the processing contents, thus decided on, containing a flow entry, as a response (step SC3). The above described sequence of operations is reiterated. Again, these steps represent a minimum set of operations.

It is noted that, in FIG. 3 and in FIG. 4, the behaviors provided in OpenFlow Switch Specification Version 1.0.0 of Non-Patent Literature 2 are shown modeled. However, these behaviors may also be modeled in accordance with the specifications of any other version provided that a device for network verification 1 is able to cope with such other version. On the other hand, the above mentioned property does not necessarily have to be defined in the information for verification D11. If the property is undefined, it is sufficient that a typical property is to be verified, in which case the device for network verification as well as any other component is to operate as though the above mentioned typical property is defined in the information for verification D11.

The verification code formulation unit 12 includes the over approximate model formulation unit 121 and the over approximate model conversion unit 122. The over approximate model formulation unit 121 formulates an over approximate model D12 of the network behavior from the information for verification D11. The over approximate model conversion unit 122 formulates a code for verification D13 that verifies whether or not the over approximate model D12 satisfies the above mentioned property.

The meaning of the ‘over approximate model’ will now be shown. The over approximate model D12 is such a model that over approximates the network behavior. Such over approximation of the network behavior may be accomplished by correcting the above mentioned behavior model so that the behavior model resulting from correction will handle no concrete values of a field of the communication packet P, that is, so that the behavior model resulting from correction does not have to refer to the match conditions identifying the communication packet, within the model. In the subject exemplary embodiment, such over approximate model D12 is formulated in which the switch as well as the controller will perform an operation of applying a flow entry to the communication packet without resorting to the match conditions identifying the communication packet.

The over approximate model D12 is defined as a state machine that, similarly to the above mentioned behavior model described above, undergoes state transitions at the same time as activity steps as primitive behavior units are executed. The over approximate model D12 is defined individually for each of the terminals and the switches and for the controller(s) that together make up the network. It is noted however that, if any of the terminals or the switches perform the same behavior, individual definitions may be omitted provided that reference is made to the sole over approximate model. The global over approximate model for the entire network is defined as an over approximate model that has synthesized the over approximate models of the total of the terminals and the switches as well as the controller that make up the network. In the subject exemplary embodiment, the over approximate model conversion unit 122 formulates the code for verification D13 using the global over approximate model for the entire network. It is noted that the ‘over approximate model’ will be discussed later in more detail using an example behavior.

The meaning of the ‘code for verification’ will now be explained. The code for verification D13 describes the over approximate model D12 using an input language of the model check execution unit 13. If the model check execution unit 13 uses Spin, a model check tool, as an example, then the code for verification D13 describes the over approximate model D12 with Promela, the Spin input language.

The over approximate model D12 itself may also be the code for verification D13. For example, such a configuration is possible in which the behavior model defined in the information for verification D11 is described with the input language of the model check execution unit 13 and the code for verification D13 is directly formulated by converting the behavior model into the over approximate model D12. In this case, the over approximate model conversion unit 122 in the configuration of FIG. 2 is unneeded and hence may be excluded from the verification code formulation unit 12. Thus, in this case, the over approximate model formulation unit 121 directly routes the over approximate model D12 formulated to the model check execution unit 13.

The model check execution unit 13 uses the code for verification D13 to execute model checking to output property-satisfaction or non-property-satisfaction D14. If, as a result of the model checking, it is found that a behavior of the over approximate model D12 violates the property, the model check execution unit 13 outputs a counterexample(s) D15 which is an example of such behavior of the over approximate model. It is noted that this model checking is continued until all of the counterexamples D15 are obtained. Since the over approximate model D12, from which the code for verification D13 originated, does not handle any concrete values of communication packet fields, model checking can be executed efficiently.

The counterexample validity confirmation unit 14 includes the constraint satisfaction problem formulation unit 141 and the constraint satisfaction problem solution unit 142. The constraint satisfaction problem formulation unit 141 formulates a constraint satisfaction problem D16 from the counterexample D15 obtained by the above mentioned model checking. The constraint satisfaction problem is aimed to confirm whether or not the counterexample D15 is present in an inherent behavior of the network as well.

The constraint satisfaction problem solution unit 142 solves the constraint satisfaction problem D16 to find a single solution D17. If the counterexample D15 is present in the inherent behavior of the network as well, the solution D17 may be found and, if otherwise, the solution D17 may not be found (no solution).

If a plurality of the counterexamples D15 are found by the model checking, the constraint satisfaction problem formulation unit 141 and the constraint satisfaction problem solution unit 142 individually execute the above mentioned processing on the respective counterexamples D15. If, for example, an n-number of the counterexamples D15 is found, an n-number of solutions D17 at the maximum are found. When the solution(s) D17 is found, the solution(s) D17 is combined with the counterexample(s) D15, from which the solution(s) D17 is found, and a resulting set(s) is delivered to the verified result output unit 15.

As described above, no concrete values of the fields of the communication packets are handled by the over approximate model D12, from which originated the code for verification D13, which in turn was used in executing the model checking to find the counterexample(s) D15. Hence, it cannot be directly known from the counterexample(s) D15 from which communication packet the counterexample(s) D15 has been produced. The counterexample validity confirmation unit 14 is provided for this reason and supplies a concrete value which will indicate from which communication packet the counterexample(s) D15 is derived. If there is no concrete value of the communication packet, from which the counterexample(s) D15 is derived, it is an indication that no counterexample(s) D15 is derived in the course of the inherent network behavior.

The verified result output unit 15 outputs the verified result based on the property-satisfaction or non-property-satisfaction D14, output from the model check execution unit 13, and on the counterexample D15 solution D17 set(s), output from the counterexample validity confirmation unit 14. If the property-satisfaction or non-property-satisfaction D14 is false, indicating that the over approximate model D12 violates the property, and at least one solution D17 is obtained, the verified result output unit 15 outputs the result that the network violates the property, while also outputting the total of the combinations of the counterexamples D15 and the solutions D17. If conversely the property-satisfaction or non-property-satisfaction D14 is true, indicating that the over approximate model D12 satisfies the property, the verified result output unit 15 outputs the result that the network satisfies the property. If none of the solutions D17 is found, the verified result output unit 15 again outputs the result that the network satisfies the property.

It is noted that respective components (processing means) of the device for network verification 1 shown in FIG. 2 may be implemented by a computer program which causes a computer composing the device for network verification to execute the above mentioned processing using its hardware resources.

### [Explanation of Operation]

The operation of the exemplary embodiment 1 of the present disclosure will now be explained in detail. FIG. 5 depicts a sequence diagram showing the operation of the device for network verification according to the exemplary embodiment 1 of the present disclosure. Referring to FIG. 5, a user creates the information for verification D11, which is then supplied to the verification information input unit 11 (step S11).

In the verification code formulation unit 12, the over approximate model formulation unit 121 initially formulates the over approximate model D12 from the information for verification D11 (step S12). The over approximate model conversion unit 122 then converts the over approximate model D12 into the code for verification D13 (step S13).

In the step of formulating the over approximate model D12 (step S12), reference is made to each of the behavior models of the terminals, switches and the controller, defined in the information for verification D11, so as to perform processing to formulate the over approximate model D12. The operation for the over approximate model conversion unit 122 to formulate the code for verification D13 depends on an input language of the model check execution unit 13. However, since the over approximate model D12, from which the code for verification is formulated by conversion, is defined in the manner of a state machine, there is no essential difference in the method for conversion despite variations in the input languages. The same may be said of a case in which the behavior model defined in the information for verification D11 is described using the input language of the model check execution unit 13 and in which the code for verification D13 is directly formulated by converting the behavior model into the over approximate model D12.

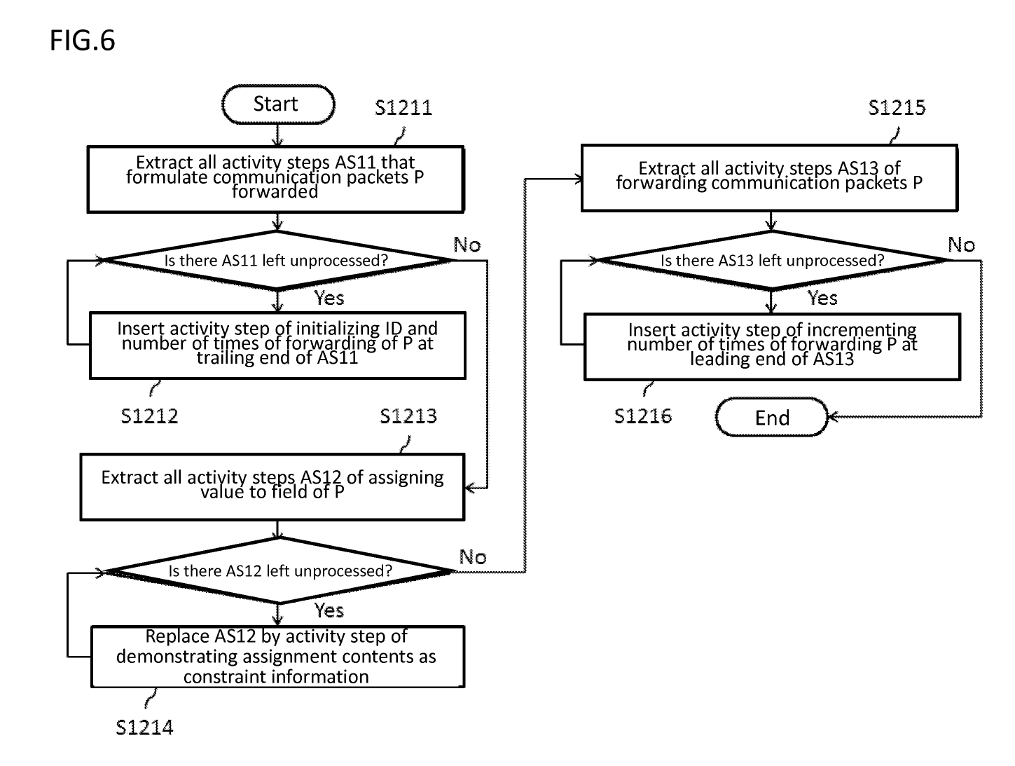

The portion of the step of formulating the over approximate model D12 (step S12), concerned with processing a behavior model for a terminal, will now be explained in detail. FIG. 6 depicts a flowchart showing an operation of the over approximate model formulation unit of the subject exemplary embodiment (the operation of formulating an over approximate model from a behavior model of a terminal). Referring to FIG. 6, initially the over approximate model formulation unit 121 extracts, from the terminal behavior model, the total of activity steps AS11 of producing or declaring a communication packet(s) to be forwarded (step S1211).

The over approximate model formulation unit 121 inserts, in a step S1212, an activity step at a trailing end of the extracted activity step. The so inserted activity step provides a field in which to record an ID to uniquely identify the communication packet and to record the number of times of packet transmission (packet forwarding), and initializes the field at an optional value. It is assumed here that the packet ID is initialized at a serial number of each communication packet and the number of times of packet transmission at zero, only by way of illustration, such that any other suitable manner of uniquely identifying the communication packet(s) as well as the number of times of packet forwarding may be used without departing from the scope of the present disclosure. The over approximate model formulation unit 121 executes the processing of the step S1212 for each of the total of the activity steps AS11 extracted in the step S1211.

The over approximate model formulation unit 121 then extracts, from the terminal behavior model, the total of the activity steps of specifying the values for the fields of the communication packets by assignment (step S1213).

The over approximate model formulation unit 121 replaces the so extracted activity step by an activity step of demonstrating, as the constraint information, the values to be assigned to the communication packets as well as the packet IDs and the number of times of forwarding (step S1214). This constraint information is used, in the same manner as any further constraint information, which will be shown later on, in the counterexample validity confirmation unit 14 which will also be detailed later on. Attention should be paid to the fact that, since the assignment activity step is replaced by an activity step which is simply a demonstration, the assignment is actually not executed. The over approximate model formulation unit 121 executes the processing of the step S1214 for the total of the activity steps extracted in the step S1213.

Finally, the over approximate model formulation unit 121 extracts, from the above mentioned terminal behavior model, the total of the activity steps of forwarding the communication packets (step S1215).

The over approximate model formulation unit 121 inserts, at a leading end of the so extracted activity steps, an activity step of incrementing the number of times of communication packet transmission by one (step S1216). The over approximate model formulation unit 121 performs the processing of the step S1216 for the total of the activity steps extracted in the step S1215. In case a plurality of terminal behavior models are individually defined, the over approximate model formulation unit 121 performs the above mentioned processing for each of these terminal behavior models.

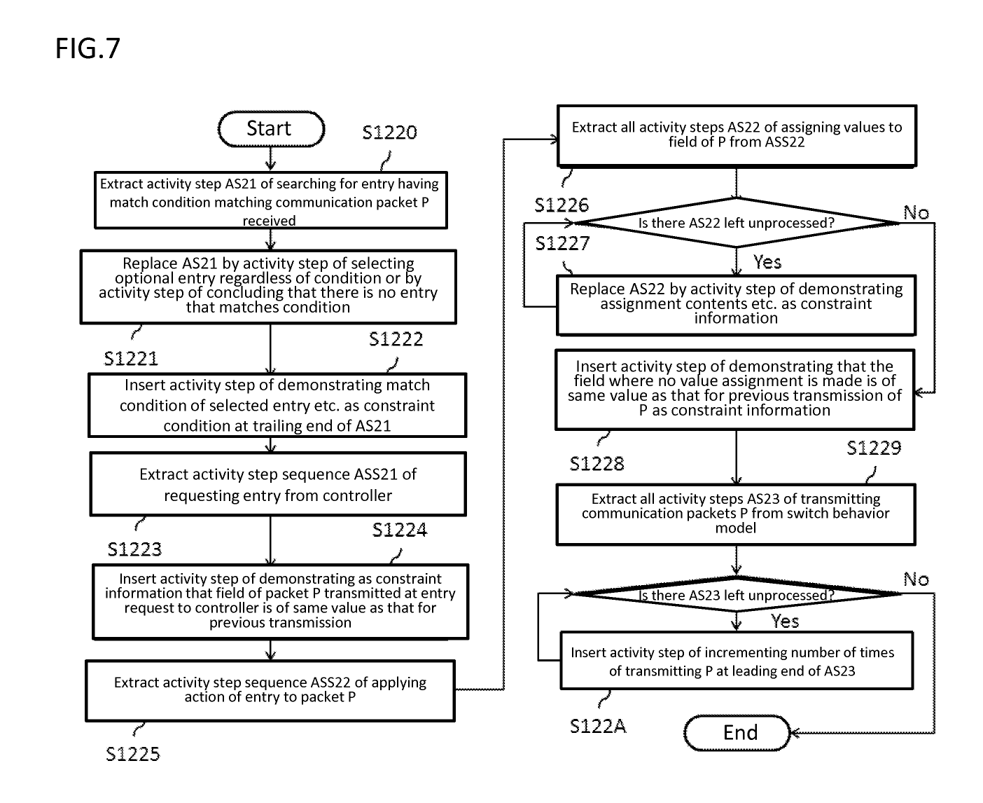

The portion of the step of formulating the over approximate model D12 (step S12) concerned with the processing for a switch behavior model will be shown in detail. FIG. 7 depicts a flowchart showing the behavior of the over approximate model formulation unit (formulation of the over approximate model from the switch behavior model) according to the subject exemplary embodiment. Referring to FIG. 7, the over approximate model formulation unit 121 initially extracts, from the switch behavior model, an activity step of searching for an entry having match conditions matching the received communication packet P (step S1220). This searching activity step is equivalent to SS2 in FIG. 3.

The over approximate model formulation unit 121 replaces the so extracted activity step by an activity step of selecting an optional entry regardless of the match conditions or by an activity step of concluding that there is no entry matching the match conditions (step S1221). The over approximate model formulation unit 121 also inserts, at the trailing end of the replacing activity step, an activity step which demonstrates constraint information along with the packet IDs and the number of times of forwarding of the communication packets (step S1222). In case the replacing activity step in the step S1221 is the step of selecting an optional processing rule (entry) regardless of the match conditions, an activity step demonstrating the match conditions of the entry is inserted as the constraint information. In case the replacing activity step in the step S1221 is the step of concluding that there is no processing rule (entry) matching the match conditions, the activity step demonstrating the match condition that has been taken to be not matching the matching conditions of any of the entries is inserted as the constraint information.

The over approximate model formulation unit 121 then extracts, from the switch behavior model, an activity step sequence ASS 21 which requests an entry from the controller (step S1223). The over approximate model formulation unit 121 then inserts, at a leading end of the so extracted activity step sequence, an activity step which demonstrates, as the constraint information, that the header field of a communication packet, sent with the request made to the controller, is of the same value as that for the directly previous transmission (step S1224).

The over approximate model formulation unit 121 then extracts, from the switch behavior model, an activity step sequence ASS22 which applies to the communication packet P an action as set in the entry (S1225). The over approximate model formulation unit 121 then extracts, from the activity step sequence extracted, the total of the activity steps of rewriting the values of the header fields by assignment (step S1226). The over approximate model formulation unit 121 also replaces each of the so extracted activity steps by an activity step of demonstrating constraint information along with the packet IDs and the number of times of forwarding (step S1227). The constraint information here is a value assigned to the communication packet P by an action of rewriting the header field value by assignment.

The over approximate model formulation unit 121 executes the processing of the step S1227 for the total of the activity steps extracted in the step S1226. Attention should be paid to the fact that, since the activity step of rewriting by assignment is replaced by an activity step which simply demonstrates the constraint information, the assignment is actually not executed.

The over approximate model formulation unit 121 then inserts, in a step S1228, an activity step of demonstrating constraint information directly before the behavior of forwarding the communication packet within the activity step sequence extracted in the step S1225. If there is no behavior of forwarding the communication packet, the activity step of demonstrating constraint information is inserted at the trailing end of the activity step sequence. The constraint information here is such one stating that each of the header fields in which no value is written by assignment at the time of header field value assignment holds the same value as that at the time of the directly previous transmission.

The over approximate model formulation unit 121 then extracts the total of the activity steps of forwarding communication packets from the switch behavior model (step S1229). The over approximate model formulation unit 121 also inserts, at a leading end of the extracted activity step, an activity step of incrementing the number of times of packet forwarding by one (step S122A). The over approximate model formulation unit 121 performs the processing of the step S122A for the total of the activity steps extracted in the step S1229. In case a plurality of the switch behavior models are individually defined, the over approximate model formulation unit 121 executes the above mentioned processing for the respective behavior models.

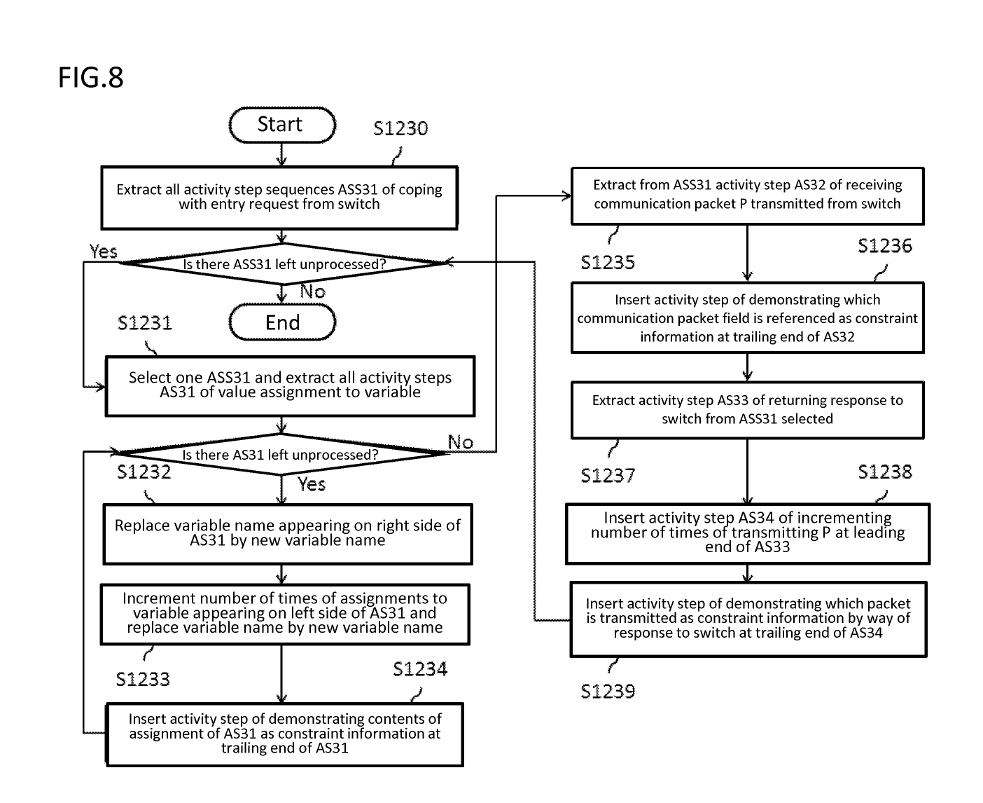

The portion of the step of formulating the over approximate model D12 (step S12) concerned with processing of a controller behavior model will now be stated in detail. FIG. 8 depicts a flowchart showing the behavior of the over approximate model formulation unit of the subject exemplary embodiment, that is, the behavior of formulating the over approximate model from the controller behavior model. Referring to FIG. 8, the over approximate model formulation unit 121 extracts, from the controller behavior model, the total of activity step sequences ASS31 which execute processing of coping with an entry request from a switch (step S1230).

The over approximate model formulation unit 121 selects one of the activity step sequences extracted, and extracts, in a step S1231, the total of the activity steps of assigning values to a variable (assignment sentences) in accordance with the order of execution of the activity step sequence. The over approximate model formulation unit 121 references the source side of assignment of the activity step extracted, that is, the right side of the assignment sentence. If a variable(s) is used, the over approximate model formulation unit replaces the number of times of assignments of the variable(s) by a new variable name in which the value of the number of times of the assignments is appended to the trailing end of the variable name (step S1232).

It is noted that the number of times of the assignments to the variable is to be stored from one variable to another throughout the present processing. Although it is here assumed that the initial value of the number of times of the assignments to the variable is zero, any other suitable value may be used without restrictions if the value used is such a one that uniquely specifies the number of times of the assignments. For example, if the activity step of x=x+1 is extracted, and the number of times of the assignments to x at the moment in time of the extraction is zero, the over approximate model formulation unit 121 replaces the activity step of x=x+1 by x=x0+1.

The over approximate model formulation unit 121 then references the destination side of the assignment of the activity step, that is, the left side of the assignment sentence, and increments the number of times of assignments to the variable used by one. The over approximate model formulation unit also replaces the variable by a new variable name in which the number of times of assignments to the variable is appended at the trailing end of the variable name (step S1233). For example, the activity step, replaced in the directly preceding case by x=x0+1, is further replaced by x1=x0+1.

The over approximate model formulation unit 121 further inserts, at the trailing end of the activity step, obtained in the step S1233 (replacing assignment sentence), an activity step showing assignment contents, by way of the constraint information (step S1234).

The over approximate model formulation unit 121 performs the processing of the steps S1232 to S1234, for the total of the activity steps extracted in the step S1231.

The over approximate model formulation unit 121 then extracts, from the activity step sequence, selected in the step S1231, the activity step of receiving the communication packet P sent from the switch (step S1235). The over approximate model formulation unit 121 inserts an activity step demonstrating which is the communication packet that has its field referenced, at the trailing end of the extracted activity step within the above mentioned activity step sequence, as the constraint information, along with the ID of the communication packet forwarded from the switch and the number of times of forwarding (step S1236).

The over approximate model formulation unit 121 extracts, from the activity step sequence selected in the step S1231, an activity step of returning a response to the switch (step S1237). The over approximate model formulation unit 121 further inserts, at the leading end of the extracted activity step, an activity step of incrementing the number of times of packet forwarding from the switch by one (step S1238). Additionally, the over approximate model formulation unit 121 inserts, at the trailing end of the activity step inserted in the step S1238, an activity step of demonstrating which is the value of the header field of the communication packet that is to be transmitted, by way of a response to the switch, as the constraint information, along with the ID of the communication packet and the number of times of forwarding (S1239).

The over approximate model formulation unit 121 executes the processing of the steps S1231 to S1239 for the total of the activity step sequences extracted in the step S1230. If definition of a plurality of controller behavior models has been made individually, the over approximate model formulation unit 121 executes the above mentioned processing for each of the behavior models.

There is no particular limitation to the order of processing behaviors performed on the behavior models of the terminals, switches and the controllers described above. The processing behaviors may be carried out in an order defined by the information for verification D11. Alternatively, the order may be modified to another specified one, and the processing may be executed in accordance with the so modified order. The over approximate model formulation unit 121 formulates the global over approximate model D12 for the entire network by carrying out the above processing for the total of the behavior models for the terminals, switches and the controllers.

The model check execution unit 13 executes model checking for the code for verification D13 formulated by the verification code formulation unit 12 (step S14) to formulate the property-satisfaction or non-property-satisfaction D14. In case the above mentioned property is violated, a counterexample(s) D15 is formulated as well.

A routine model checking is terminated in a majority of cases at a moment of time of detection of one counterexample. However, with the model check execution unit 13 of the subject exemplary embodiment, model checking is not terminated on detection of a single counterexample, and is continued until detection of the total of the counterexamples.

On detection of the counterexample D15, the constraint satisfaction problem formulation unit 141 of the counterexample validity confirmation unit 14 formulates the constraint satisfaction problem D16 from the counterexample D15 (step S15). The constraint satisfaction problem solution unit 142 then solves the constraint satisfaction problem D16 to get a solution D17 (step S16).

In more detail, the constraint satisfaction problem formulation unit 141 extracts the total of the contents within the counterexample D15, demonstrated by the processing by the verification code formulation unit 12 as the constraint information, and converts the contents extracted into an expression of the constraint satisfaction problem to generate the constraint satisfaction problem D16. If the solution D17 to the problem is found, it is combined with the counterexample D15, and the resulting combination of the solution and the counterexample D15, from which the solution has been found, is delivered to the verified result output unit 15.

The verified result output unit 15 outputs a verified result, based on the property-satisfaction or non-property-satisfaction D14, output from the model check execution unit 13, and on the counterexample D15 as well as the solution D17, output from the counterexample validity confirmation unit 14 (step S17). More specifically, if the property-satisfaction or non-property-satisfaction D14 is false, that is, the over approximate model D12 violates the above mentioned property, and at least one solution D17 has been found, the verified result output unit 15 outputs the result that the network violates the above mentioned property, while also outputting the total of the combinations of the counterexamples D15 and the solutions D17.

If the property-satisfaction or non-property-satisfaction D14 is true, that is, the over approximate model D12 satisfies the above mentioned property, or if none of the solutions D17 has been found, the verified result output unit 15 outputs a result that the network satisfies the above mentioned property.

The user acknowledges the result output by the step S17 (step S18).

It is seen from above that, in the device for network verification 1 of the subject exemplary embodiment, the verification code formulation unit 12 formulates a model which has over-approximated the behavior of the OpenFlow network so as not to handle any concrete values of the communication packet field. The code for verification which verifies if the over approximate model satisfies the property is then formulated. The model check execution unit 13 then performs model checking, using the code for verification. By so doing, efficient model checking may be performed in which it is unnecessary to take account of the difference in the contents of packets transmitted from the terminals within the OpenFlow network. Moreover, in case the result of the model checking is such that the over approximate model violates the above mentioned property, it is possible to efficiently check by the counterexample validity confirmation unit 14 whether or not the resulting counterexample persists in the inherent behavior of the OpenFlow network as well. This enables the OpenFlow network to be efficiently exhaustively verified to detect faults without overlooking.

### Exemplary Embodiment 2

An exemplary embodiment 2 according to the present disclosure, allowing for executing verification behaviors of a network other than the OpenFlow network, will be explained in detail with reference to the drawings. Part of the subject exemplary embodiment is similar to the above described exemplary embodiment 1 and is not here explained, so that the following description is directed only to points of difference from the previous exemplary embodiment.

### [Explanation of Configuration]

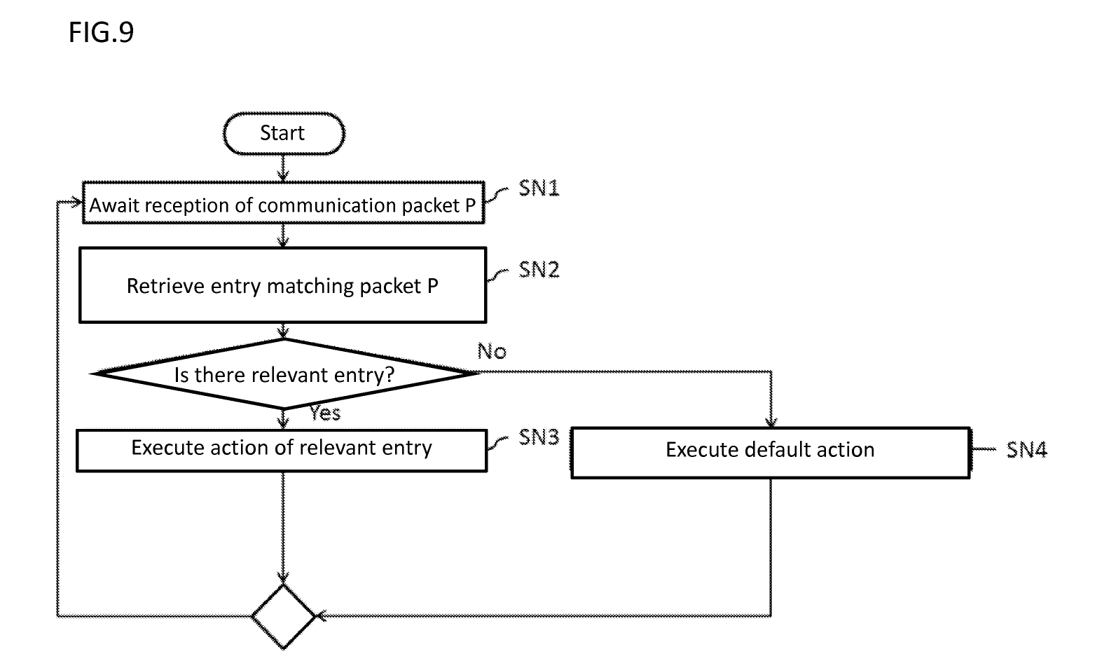

Reference is again made to FIG. 2 for explaining the configuration of the exemplary embodiment 2. A verification information input unit 11 of the exemplary embodiment 2 of the present disclosure accepts the information for verification D11 as input. The information for verification represents a definition of behavior models of the total of terminals and network components, together composing a network, the relationship of interconnections of the terminals and network components, and a property or properties to be satisfied with the network. The behavior model is made up by a plurality of sequential activity steps. FIG. 9 shows an example smallest behavior model of a network component postulated in the exemplary embodiment 2 of the present disclosure. In an instance of FIG. 9, a network component awaits receiving a communication packet P (step SN1). On receipt of a packet, the network component searches for such one of entries, implemented and set in the network component itself, which matches a destination etc. of the received packet P (step SN2). If any entry that matches the destination etc. of the received packet is found, the network component executes the contents of processing stated in the entry (step SN3). If there is no entry that matches the destination etc. of the received packet P, the network component executes the processing implemented and set as default behaviors (step SN4). The network component reiterates the above mentioned sequence of behaviors as a minimum set of behaviors.

### [Explanation of Operations]

Referring to FIG. 2 and FIG. 5, the operation of the subject exemplary embodiment 2 of the present disclosure will be explained in detail. In the verification code formulation unit 12, the over approximate model formulation unit 121 initially formulates the over approximate model D12 from the information for verification D11 (step S12). The over approximate model conversion unit 122 then converts the over approximate model D12 into the code for verification D13 (step S13).

In the step of formulating the over approximate model D12 (step S12), the over approximate model D12 is formulated by processing as reference is made to each of the behavior models of the terminals and the network components defined in the information for verification D11. The processing for formulating the over approximate model D12 from the terminal behavior model is similar to that of the exemplary embodiment 1 of the present disclosure and hence the corresponding description is dispensed with.

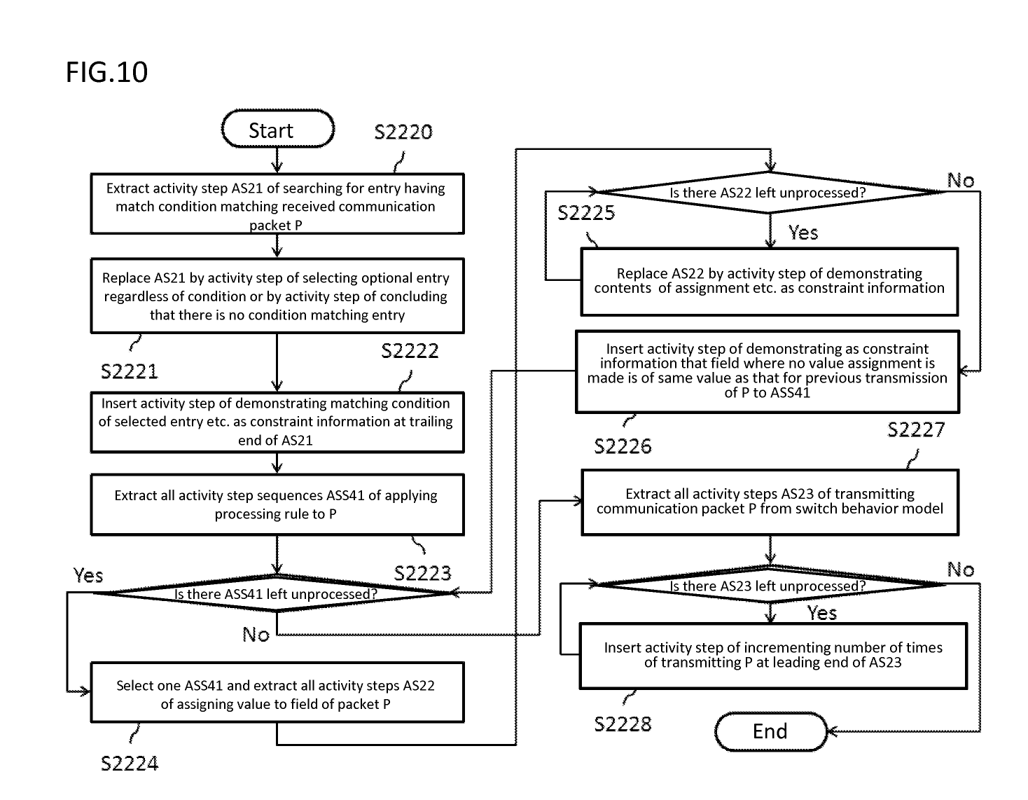

Next, the portion of the step for formulating the over approximate model D12 (step S12) concerned with the processing of the behavior model of the network component will be explained in detail. FIG. 10 depicts a flowchart showing the operation of the over approximate model formulation unit of the subject exemplary embodiment (the operation of formulating an over approximate model from a behavior model of a network component). Referring to FIG. 10, in a step S2220, the over approximate model formulation unit 121 extracts, from the behavior model of a network component, an activity step of searching for an entry matching the destination etc. of a communication packet P received (equivalent to SN2 of FIG. 9).

The over approximate model formulation unit 121 replaces the so extracted activity step by an activity step of selecting an entry regardless of the destination etc. of the communication packet P or by an activity step of concluding that there is no entry matching the destination etc. of the communication packet P (step S2221). The over approximate model formulation unit 121 also inserts, at the trailing end of the replacing activity step, an activity step showing the constraint information along with the ID of the communication packet and the number of times of forwarding (step S2222). If, in the above step S2221, the replacing activity step is the step of selecting any optional entry regardless of the destination etc. of the communication packet P, an activity step of demonstrating the destination etc. of the entry is inserted as the constraint information. On the other hand, if the replacing activity step of S2221 is the step of concluding that there is no entry matching the destination etc. of the communication packet P, an activity step of demonstrating the very condition taken to be matching none of the entry conditions is inserted.

The over approximate model formulation unit 121 then extracts, from the behavior model of a network component, the total of activity step sequences ASS41 of executing processing contents for the communication packet P as set in an entry (S2223). The over approximate model formulation unit 121 then extracts, from each of the activity step sequences extracted, the total of activity steps of rewriting header field values by assignment (step S2224). The over approximate model formulation unit 121 then replaces each of the so extracted activity steps by an activity step of demonstrating the constraint information along with the ID of the communication packet and the number of times of forwarding (S2225). The constraint information here is a value to be assigned to each communication packet P by value assignment to its header field.

The over approximate model formulation unit 121 executes the processing of the step for the total of the activity steps extracted in the step S2224. Note that, since the activity step S2225 is the step of replacing the header field values by assignment by the activity step of simply demonstrating the constraint information, assignment is actually not executed.

The over approximate model formulation unit 121 then inserts, within the activity step sequence, extracted by the step S2223, directly before the behavior of forwarding the communication packet, an activity step of demonstrating the constraint information (step S2226). Note that, if there is no behavior of forwarding the communication packet, the demonstrating activity step is to be inserted at the trailing end of the activity step sequence. The contents of the constraint information here are such that, for each header field, the value of which is not rewritten at the time of rewriting by assignment, the field is of the same value as that at the time of the previous forwarding of the communication packet.

The over approximate model formulation unit 121 executes the processing of the steps S2224 to S2226 for the total of the activity step sequences extracted in the step S2223.

The over approximate model formulation unit 121 then extracts the total of the activity steps of communication packet transmission from the behavior model of the network component (step S2227). The over approximate model formulation unit 121 also inserts, at a leading end of each activity step extracted, an activity step of incrementing the number of times of packet forwarding by one (step S2228). The over approximate model formulation unit 121 executes the processing of the step S2228 for each of the total of the activity steps extracted in the step S2227. If definition is individually made of each of a plurality of the behavior models of the network components, the over approximate model formulation unit 121 executes the above processing on the respective behavior models.

In the above described exemplary embodiment 2, the verification code formulation unit 12 of the device for network verification 1 formulates a model which has over-approximated the network behavior so as not to handle any concrete values of the fields of the communication packets. The verification code formulation unit then formulates the code for verification which verifies whether or not the over approximate model will satisfy the property. The model check execution unit 13 executes model checking, using the code for verification, so that efficient model checking may be accomplished in which there is no necessity to take account of the difference in the contents of packets sent from the terminals within the network. Should the result of the model checking be such that the over approximate model violates the above mentioned property, the counterexample validity confirmation unit 14 checks to see whether or not the counterexample also is present in the inherent behavior of a network in question.

Thus, in the subject exemplary embodiment, any network other than the OpenFlow network may be verified efficiently exhaustively to detect faults without overlooking.

### Exemplary Embodiment 3

An exemplary embodiment 3 according to the present disclosure, which has improved a user interface of the above described exemplary embodiments 1 and 2, will now be described with reference to the drawings. In the following, description is made only of the points of difference of the subject exemplary embodiment from the exemplary embodiment 1 described above and description is not made of points of similarity of the subject exemplary embodiment to the exemplary embodiment 1.

### [Explanation of the Configuration]

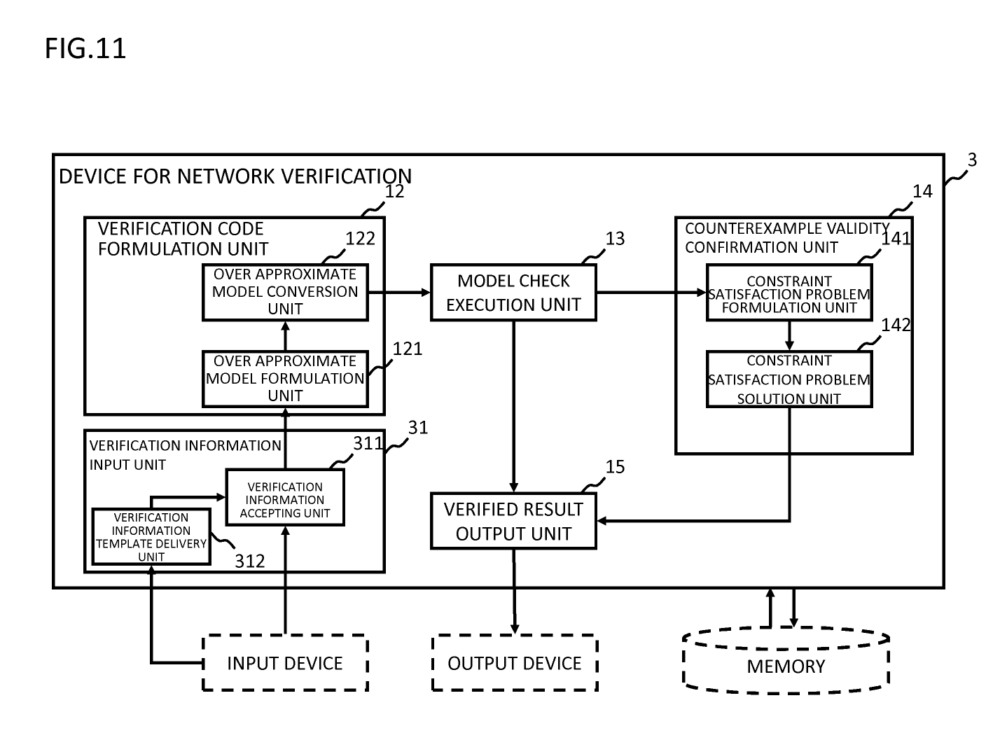

FIG. 11 depicts a block diagram showing the configuration of a device for network verification according to an exemplary embodiment 3 of the present disclosure. A verification information input unit 31 includes a verification information accepting unit 311 and a verification information template delivery unit 312. The verification information accepting unit 311 accepts information for verification D11 as input. The information for verification represents a definition of behavior models of the total of terminals, switches, a controller(s), network components etc., making up a network, the relationship of interconnections of the terminals, switches, controllers, network components etc. and the property or properties which are to be met by the network.

In accepting an input of the information for verification from a user, the verification information template delivery unit 312 presents a typical template(s) for part or all of the information for verification D11 in order for a user to select the template(s) presented. The template(s) presented may be utilized as part or all of the information for verification D11 and delivered to the verification information accepting unit 311.

### [Explanation of the Operation]

In formulating the information for verification D11 in the step S11 of FIG. 5, the user selects one or more of the templates he/she likes, from the verification information template delivery unit 312. Using the template(s), the user completes the information for verification D11 which is then entered to the verification information accepting unit 311. Of course, the user may formulate the information for verification D11 without using any template(s) and enter the so formulated information for verification to the verification information accepting unit. The operation is otherwise similar to that of the exemplary embodiment 1 and hence the corresponding detailed description therefor is dispensed with.

According to the subject exemplary embodiment, it is possible to relieve the user of the onus in formulating the information for verification D11 in utilizing the device for network verification. Moreover, according to the subject exemplary embodiment, since the onus on the part of the user may be relieved, the verification operation in its entirety may be improved in efficiency.

Although certain preferred exemplary embodiments of the present invention are shown above, the present invention is not to be restricted to any of these particular modes, such that further changes, substitutions or adjustments may be made within the range not departing from the basic technical concept of the invention. For example, the configurations of various means or units, shown in the drawings, are given merely as illustrative to assist in the understanding of the present invention which is not to be restricted to the configurations shown.

Finally, certain preferred modes of the present invention will be summarized.

### [Mode 1]

(Reference is made to the apparatus for verifying a network for verifying a network according to the above mentioned first aspect).

### [Mode 2]

The apparatus for verifying a network according to mode 1, wherein,

an OpenFlow switch and an OpenFlow controller are provided in the network being verified; and wherein the information for verification also represents definition of respective behavior models of the OpenFlow switch and the OpenFlow controller.

### [Mode 3]

The apparatus for verifying a network according to mode 1 or 2, wherein,

the counterexample validity confirmation unit includes

a constraint satisfaction problem formulation unit that acquires, from the counterexample, the constraint information concerning the constraint to be satisfied when the counterexample is actually carried out, and that formulates a constraint satisfaction problem from the constraint information; and

a constraint satisfaction problem solution unit that finds a solution of the constraint satisfaction problem to check whether or not the counterexample can be executed in an inherent behavior of the network as well.

### [Mode 4]

The apparatus for verifying a network according to any one of modes 1 to 3, wherein,

the verification information input unit accepts, from a user, an inputting of a property of the network being verified as part of the information for verification.

### [Mode 5]

The apparatus for verifying a network according to any one of modes 1 to 4, wherein,

the verification information input unit presents to a user a template(s) that stipulates typical contents of part or all of the information for verification;

the verification information input unit accepting an inputting of at least part of the information for verification subject to selection of the template(s).

### [Mode 6]

(Reference is made to the method for verifying a network according to the above mentioned second aspect).

### [Mode 7]

(Reference is made to the program according to the above mentioned third aspect).

It is noted that each of the above modes 6 and 7 may be expanded in the same way as the mode 1 so as to comprise modes 2 to 5.

The disclosures of the above mentioned patent literatures are to be incorporated herein by reference. The exemplary embodiments or examples may be modified or adjusted within the concept of the total disclosures of the present invention, inclusive of claims, based on the fundamental technical concept of the invention. A wide variety of combinations or selections of elements herein disclosed (elements of claims, exemplary embodiments, examples and drawings) may be made within the context of the claims of the present invention. That is, the present invention may include a wide variety of changes or corrections that may occur to those skilled in the art in accordance with the total disclosures inclusive of the claims and the drawings as well as the technical concept of the invention. In particular, it should be understood that any optional numerical figures or sub-ranges contained in the ranges of numerical values set out herein ought to be construed to be specifically stated even in the absence of explicit statements.

What is claimed is:

1. An apparatus for verifying a network, comprising:
a verification information input unit that accepts an input of information for verification which represents definition of a configuration of a network being verified and a behavior model(s) of a component(s) included in the network;
a verification code formulation unit that formulates, from the information for verification, a code for verification which verifies an over approximate model; the over approximate model being such a model that has corrected the behavior model so that the model obtained on correction does not have to resort to match conditions identifying a communication packet;
a model check execution unit that executes model checking using the code for verification;
a counterexample validity confirmation unit that checks whether or not a counterexample obtained in the model checking is also present in an inherent behavior of the network; and
a verified result output unit that outputs a result of verification based on outputs of the model check execution unit and the counterexample validity confirmation unit.

2. The apparatus for verifying a network according to claim 1, wherein,
an OpenFlow switch and an OpenFlow controller are provided in the network being verified; and wherein,
the information for verification also represents definition of respective behavior models of the OpenFlow switch and the OpenFlow controller.

3. The apparatus for verifying a network according to claim 1, wherein,
the counterexample validity confirmation unit includes
a constraint satisfaction problem formulation unit that acquires, from the counterexample, the constraint information concerning the constraint to be satisfied when the counterexample is actually executed, and that formulates a constraint satisfaction problem from the constraint information; and
a constraint satisfaction problem solution unit that finds a solution of the constraint satisfaction problem to check whether or not the counterexample can be executed in an inherent behavior of the network as well.

4. The apparatus for verifying a network according to claim 1, wherein,
the verification information input unit accepts, from a user, an input of a property of the network being verified as part of the information for verification.

5. The apparatus for verifying a network according to claim 1, wherein,
the verification information input unit presents to a user a template(s) that stipulates typical contents of part or all of the information for verification;
the verification information input unit accepting an inputting of at least a part of the information for verification subject to selection of the template(s).

6. A method for verifying a network, comprising:
accepting an input of information for verification which represents definition of a configuration of a network being verified and a behavior model(s) of a component(s) included in the network;
formulating, from the information for verification, a code for verification which verifies an over approximate model; the over approximate model being such a model that has corrected the behavior model so that the model obtained on correction does not have to resort to match conditions identifying a communication packet;
executing model checking using the code for verification;
checking whether or not a counterexample obtained in the model checking is also present in an inherent behavior of the network as well; and
outputting a result of verification based on outputs of the model check execution and the counterexample validity confirmation.

7. A non-transitory computer-readable recording medium storing thereon a program that causes a computer that verifies a behavior of a network to perform processing for:
accepting an input of information for verification which represents definition of a configuration of a network being verified and a behavior model(s) of a component(s) included in the network;
formulating, from the information for verification, a code for verification which verifies an over approximate model; the over approximate model being such a model that has corrected the behavior model so that the model obtained on correction does not have to resort to match conditions identifying a communication packet;
executing model checking using the code for verification;
checking whether or not a counterexample obtained in the model checking is also present in an inherent behavior of the network; and
outputting a result of verification based on outputs of the model check execution and the counterexample validity confirmation.

8. The apparatus for verifying a network according to claim 2, wherein,
the counterexample validity confirmation unit includes
a constraint satisfaction problem formulation unit that acquires, from the counterexample, the constraint information concerning the constraint to be satisfied when the counterexample is actually executed, and that formulates a constraint satisfaction problem from the constraint information; and
a constraint satisfaction problem solution unit that finds a solution of the constraint satisfaction problem to check whether or not the counterexample can be executed in an inherent behavior of the network as well.

9. The apparatus for verifying a network according to claim 2, wherein,
the verification information input unit accepts, from a user, an input of a property of the network being verified as part of the information for verification.

10. The apparatus for verifying a network according to claim 3, wherein,
the verification information input unit accepts, from a user, an input of a property of the network being verified as part of the information for verification.

11. The apparatus for verifying a network according to claim 2, wherein,
the verification information input unit presents to a user a template(s) that stipulates typical contents of part or all of the information for verification;
the verification information input unit accepting an inputting of at least a part of the information for verification subject to selection of the template(s).

12. The apparatus for verifying a network according to claim 3, wherein,
the verification information input unit presents to a user a template(s) that stipulates typical contents of part or all of the information for verification;
the verification information input unit accepting an inputting of at least a part of the information for verification subject to selection of the template(s).

13. The apparatus for verifying a network according to claim 4, wherein,
the verification information input unit presents to a user a template(s) that stipulates typical contents of part or all of the information for verification;
the verification information input unit accepting an inputting of at least a part of the information for verification subject to selection of the template(s).
